(19) United States
(12) Patent Application Publication
(10) Pub. No.: US 2014/0188970 A1
(43) Pub. Date: Jul. 3, 2014

(54) SYSTEM AND METHOD ENABLING SERVICE AND APPLICATION ROAMING

(71) Applicant: CLOUDCAR, INC., Los Altos, CA (US)

(72) Inventors: Ajay Madhok, Los Altos, CA (US); Evan Malahy, Santa Clara, CA (US); Ron Morris, Seattle, WA (US)

(73) Assignee: CloudCar, Inc., Los Altos, CA (US)

(21) Appl. No.: 13/730,917

(22) Filed: Dec. 29, 2012

(51) Int. Cl. H04L 29/08

(52) U.S. Cl. CPC H04L 67/04
USPC 709/201

(57) ABSTRACT

A system and method enabling service and application roaming are disclosed. A particular embodiment includes: unifying a plurality of user services and applications from a plurality of sources in an environment into a shared ecosystem of services and applications; assigning, by use of a data processor, a digital identity to the shared ecosystem of services and applications; detecting a context change in the environment causing a transition to a current context; causing a task set to be performed in response to the context change; and dispatching a set of interaction resources, corresponding to the task set, to present a state of the current context to a user by use of a plurality of interaction devices corresponding to the set of interaction resources, the set of interaction resources being accessed using the plurality of user services and applications in the shared ecosystem of services and applications.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2010-2012, CloudCar Inc., All Rights Reserved.

### TECHNICAL FIELD

This patent document pertains generally to tools (systems, apparatuses, methodologies, computer program products, etc.) for allowing electronic devices to share information with each other, and more particularly, but not by way of limitation, to an environment supported by a cloud-based vehicle information and control system.

### BACKGROUND

An increasing number of vehicles are being equipped with one or more independent computer and electronic processing systems. Certain of the processing systems are provided for vehicle operation or efficiency. For example, many vehicles are now equipped with computer systems for controlling engine parameters, brake systems, tire pressure and other vehicle operating characteristics. A diagnostic system may also be provided that collects and stores information regarding the performance of the vehicle's engine, transmission, fuel system and other components. The diagnostic system can typically be connected to an external computer to download or monitor the diagnostic information to aid a mechanic during servicing of the vehicle.

Additionally, other processing systems may be provided for vehicle driver or passenger comfort and/or convenience. For example, vehicles commonly include navigation and global positioning systems and services, which provide travel directions and emergency roadside assistance. Vehicles are also provided with multimedia entertainment systems that include sound systems, e.g., satellite radio, broadcast radio, compact disk and MP3 players and video players. Still further, vehicles may include cabin climate control, electronic seat and mirror repositioning and other operator comfort features.

However, each of the above processing systems is independent, non-integrated and incompatible. That is, such processing systems provide their own sensors, input and output devices, power supply connections and processing logic. Moreover, such processing systems may include sophisticated and expensive processing components, such as application specific integrated circuit (ASIC) chips or other proprietary hardware and/or software logic that are incompatible with other processing systems in the vehicle or the surrounding environment.

Today, a user consumes many mobile applications (apps) and cloud services. Consumers expect that these applications and cloud services are available and can be consumed in any connected environment (e.g., a vehicle with network connectivity, an environment with a connected device like a smart phone or a smart TV; and a connection to the internet like a network-connected home or office, or the like). Users expect that just like their voice and data roams with them as when they move from one location to another; their application and cloud service experience, should also roam with them—from one device to another device; and one connected environment to another connected environment. Although the consumer expectation, in general, is that their set of applications and services are available across different screens, devices, and environments, experience roaming imposes higher expectations. Better experience roaming makes the applications and services not only available, but also useful, usable, and desirable in those environments. Conventional solutions have not met that standard.

A satisfying user experience is more than just being connected to the application or an application being available on a given device in a given environment. Experience satisfaction also includes the way a user feels about the experiential, meaningful and personally relevant aspects of the application. These aspects of the experience need to be preserved even though the user interface and the human-computer interaction may change from device to device or environment to environment The experience needs to dynamically adapt to the user's temporal context as well as take into account the available computing and interaction resources that are available in that connected environment. Hence, experience roaming should go beyond just making an application available. Experience roaming should preserve what makes an application useful, usable, and desirable to a user across their connected environments. The experience should adapt and transform the presentation and expression based on the available resources ensuring that the practical aspects of the experience, such as utility, ease of use, and efficiency are preserved. Again, conventional solutions have not met that standard.

As an example, a user might be positioned in front of their network-connected TV as one of the devices in their home, which might represent a connected environment. If the user receives an on-TV notification alerting the user to an incoming telephone call, but the connected environment does not enable the user to answer that call in that environment, the environment is not considered to support experience roaming. Genuine experience roaming would enable the phone service experience to roam from a mobile device environment to a TV environment and enable the user to take actions, such as pause the TV, take the call using the TV's available microphone and speaker, and resume watching TV from where they left alter the call was over. Experience roaming should also enable the user to pick a contact from their address book using the interaction resources available in that environment (e.g., the TV remote, voice commands, etc.) and make a phone call while in front of the TV. Experience roaming should mean that the physical connection and access to the mobile device resources, such as the address book on the mobile device, are transparent to the user. If the user is in a connected environment with a TV as a primary display device, the user should still have access to mobile device resources via the TV. These resources should be available to the user on the TV device and any related user interfaces should get presented on the TV in a useable manner so that user can meet their telephony goals in that environment.

While, some use cases have been addressed in a pairwise manner (e.g., some apps partially roam on some connected device screens and environments), there is no general purpose framework that enables the experience of a user-selected set of applications or services to roam across other connected devices and environments while preserving the apps' utility, usability, and experiential value. The connected vehicle is one such environment where this problem manifests itself when consumers want to bring along their mobile applications and cloud services to their vehicle as a connected environment. Currently, there are three approaches (described below) for making applications available in a vehicle; but, none of these approaches address or support experience roaming.

One conventional approach is mirroring the mobile phone onto the vehicle's IVI (in-Vehicle Infotainment) systems or head unit display. Simply mirroring the mobile phone interface onto the vehicle's display does not solve the problem or support experience roaming, because the mobile applications, although now available, cannot be consumed as such in a moving vehicle. The high-sensitivity touch user interfaces designed for the mobile device are just not usable as such in a moving vehicle. These interfaces require far too much cognitive, manual, and visual workload to understand what is being presented, how to use it, and how to make sense of their interactions. Further, mirroring only deals with the view part of the application and not the control part of the application. Mirroring does not adapt or transform the user interfaces of these applications into a form that is vehicle-appropriate (e.g., usable in the vehicle); Finally, mirroring does not take into account the changing context of the vehicle-environment; does not leverage the available in-vehicle interaction resources; and does not fake into account the fact that using the application in a moving vehicle increases the manual, visual, and cognitive workload on the driver. Hence, the application interface would have to be re-designed for it to be vehicle-centric, presenting user interfaces and interaction patterns that can be safely used in a moving vehicle. In other words, mirroring only makes applications somewhat available, but does not make them usable or desirable in the vehicle's environment.

Another conventional approach is to create native instances of the mobile applications that leverage the in-vehicle resources and express the application as vehicle-appropriate. This makes the application useful and usable in the vehicle. However, the problem with this approach is that making mobile applications available as native in-vehicle apps is expensive, time consuming, and requires pair-wise integration between the application and the vehicle's platform and the available in-vehicle human-machine interface (HMI) resources. This means that this solution is available only for the few applications that are handpicked by the vehicle original equipment manufacturers (OEMs) and integrated into the vehicle platform. However, a large number of applications and services at large that a user may want to be available will not be supported.

A variant to this approach is writing applications using Hypertext Markup Language Rev. 5 (HTML5). This may address the diversity of vehicle platforms problem, as potentially, an HTML5 browser can be made available on all vehicle platforms. However, HTML5 does not make the applications usable as such, because these apps have not been designed for vehicle as the target environment. Thus, the user interfaces that these applications present may not be appropriate for consumption in a moving vehicle.

Additionally, there is a higher order problem that these approaches cannot solve, that is, providing an integrated user experience. Switching from application to application changes the experience context and consumes all of the available cognitive resources of the driver. Solving context switching across applications is outside the domain of influence of a single application. While natively written applications (hand-picked by the OEM) strive to provide a consistent, OEM specified experience, the experience is not integrated as one continuous whole. Mirroring or HTML5 applications do not even guarantee that any of the user selected applications will have the same interface. Hence, switching between applications results in context switching, which increases the driver workload and renders the applications less usable or desirable.

In summary, none of these conventional approaches (e.g., mirroring, native apps or non-native apps) address the user experience problem holistically or support genuine experience roaming.

### SUMMARY

A system and method enabling service and application roaming is described herein in various example embodiments. Roaming in the context of voice or telephony generally refers to the extension of connectivity service in a location that is different from the home location where the telephony service was registered. For example, a voice roaming service ensures that as the user roams or moves around, their mobile/wireless telephony device is kept connected to the network, without losing the connection, including when a call is in progress. Voice roaming got extended In conventional telephony services to cover data as well and it meant that the data connection was maintained as the user moved around.

In the context of a connected vehicle, experience roaming, as described herein, means that the user expects that their entire set of connected life experiences to roam with them. This means they do not have to tell the vehicle who they are, who their friends are, what apps and services they consume on their mobile device, on their tablet or at home or at work. Their entire ecosystem of services and apps remains available and active as they enter their vehicle and drive around; but, the experience gets transformed appropriately, making it vehicle-appropriate and safe.

The system and method enabling service and application roaming, described herein in various example embodiments, enables the service and app roaming experience to travel with the user, transforming the experience appropriately for consumption (presentation and interaction) in a moving vehicle. The service and application roaming described herein unifies the siloed worlds of various mobile apps, cloud services and vehicle data, sensory intelligence and vehicle services into one consistent experience that is vehicle safe, relevant, and inclusive while addressing distracted driving.

The system and method enabling service and application roaming, described herein, incarnates the application to deliver a safe, vehicle-centric experience when a smartphone gets paired with the car. In the system model described herein, while the application continues to run on the smartphone, the application experience gets transformed to an implementation presented in a vehicle-safe manner. Additionally, the application experience gets transformed so the user can interact with the application using in-vehicle controls. This application experience transformation is denoted herein as Experience Roaming to suggest that the user gets a consistent experience as they move from the direct use of their mobile device to use of the mobile device in and with a vehicle's available computing environment and interaction resources. This means the user does not have to tell the vehicle who they are, who their friends are, what apps and services they consume on their mobile device, on their tablet or at home or at work. The user gets a consistent experience; because, their devices, data and services get linked to their digital identity and the experience roams with the identity from device to device, location to location, and context to context. The services and applications of the shared ecosystem of services and applications remain available using their digital identity; but, the experiences get appropriately transformed preserving their utility, usability, and desirability.

The system and method enabling service and application roaming is described herein in various example embodiments. The various embodiments enable experience roaming that is lacking in conventional systems. Instead of just making an application “available” in a connected environment by mirroring the user interface that was designed for another device, the embodiments described herein decouple the application's user interface from the application's functionality. The embodiments described herein specify the application in terms of its intent(s), that is, the set of tasks that help a user accomplish a certain goal. The application intent could be enabling a user task (or an activity), a service, or delivering a notification to the user. The application's intent can be specified in application messages. These messages can carry the information required to understand the temporal intent of the application in terms of the object (e.g., the noun or content) of the application, the input/output (I/O) modality of the intent/task at hand (e.g., how to present the object to the user), and the actions (e.g., the verbs associated with the application) that can be associated with the task at hand (the intent). As such, an intent as used herein can refer to a message, event, or request associated with a particular task, application, or service in a particular embodiment. One example embodiment provides a Service Creation interface that enables the developer of the application or service to describe their application's intent so that the application's intent can be handled/processed at run-time. The description of the application's intent can include information, such as the Noun (object) upon which the application will act, the Verbs or the action, or actions that can be taken on that Noun, and the Interaction and Launch Directives that specify how to interact with that object and launch a target action or activity (e.g., the callback application programming interface—API to use). In other words, the Service Creation interface enables a developer to describe their application in terms of intents and related semantics using a controlled vocabulary of Nouns and Verbs that represent well-defined concepts specified in an environment-specific ontology. Further, an application intent description can also carry metadata, such as the application's domain or category, context of use, criticality, time sensitivity, etc. enabling the system to deal appropriately with the temporal intent of the application.

The application's temporal intent description can be received by a particular embodiment as messages. The metadata in the messages can be used to filter, order, and queue the received messages for further processing. The further processing can include transforming the messages appropriately for presentation to the user so that the messages are useful, usable, and desirable. In the context of a vehicle, the processing can also include presenting the messages to the user in a manner that is vehicle-appropriate using a consistent visual language with minimal interaction patterns (keeping only what is required to disambiguate the interaction) that are carefully designed to minimize driver distraction. The processing of ordered application intent description messages includes mapping the particular application intent descriptions to one or more tasks that will accomplish the described application intent. Further, the particular application intent descriptions can be mapped onto abstract I/O objects. At run-time, the abstract I/O objects can be visualized by mapping the abstract I/O objects onto available concrete I/O resources. The various embodiments also perform processing operations to determine where, how, and when to present application information to the user in a particular environment, so that the user can use the application, obtain results, and achieve their goals. Any number of application intent descriptions, from one or more applications, can be requested or published to the various embodiments for concurrent presentation to a user. The various intents received from one or more applications get filtered and ordered based on the metadata, such as criticality and relevance based on the knowledge of the temporal context. The various embodiments compose the application intent descriptions into an integrated user experience employing the environmentally appropriate visual language and interaction patterns. Application intent transitions and orchestration are also handled by the various embodiments. At run-time, the application intent descriptions can be received by the various embodiments using a services gateway as a message receiver.

In addition to the Service Creation interface, another interface can be provided by an example embodiment. This interface is used before the application intent descriptions are orchestrated in run-time. This interface is implemented in an example embodiment using an experience roaming widget. The widget is used by users to configure the applications and services they want to consume in the vehicle (or other connected environment). In other words, the widget is used by the user to specify the applications or services they want to enable for experience roaming. As part of the interface, the user can configure an access token giving the system the ability to receive application intent descriptions on the user's behalf. The access token enables the user to enable or disable the processing of application intent descriptions that are available for the application being configured. Any application intent description that is disabled by the user or is not subscribed to by the system is filtered out at run-time. Any application intent description that is not disabled by the user and is subscribed to by the system is presented to the user.

As described in more detail below, an example embodiment of the system and method enabling service and application roaming uses six key services.

### BRIEF DESCRIPTION OF THE DRAWINGS

The various embodiments is illustrated by way of example, and not by way of limitation, in the figures of the accompanying drawings in which:

FIG. 1 illustrates an example embodiment of the components of the system and method enabling service and application roaming;

FIG. 2 illustrates an example embodiment of the run time model of the service and application roaming system;

FIG. 3 illustrates an example of the service and application roaming in a social and vehicle related ecosystem;

FIG. 4 illustrates an example embodiment of the shared ecosystem of services and applications (apps) in an example embodiment;

FIG. 5 illustrates an example embodiment of the Two-way Messaging Service in an example embodiment;

FIG. 6 illustrates an example of the service and application roaming system in a vehicle environment in an example embodiment;

FIG. 7 is a processing flow chart illustrating an example embodiment of a system and method enabling service and application roaming; and

FIG. 8 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

As described in various example embodiments, a system and method enabling service and application roaming are described herein. In one particular embodiment, a system and method enabling service and application roaming is provided in the context of a cloud-based vehicle information and control ecosystem configured and used as a computing environment with access to a wide area network, such as the Internet. However, it will be apparent to those of ordinary skill in the art, that the system and method enabling service and application roaming described and claimed herein can be implemented, configured, and used in a variety of other applications and systems.

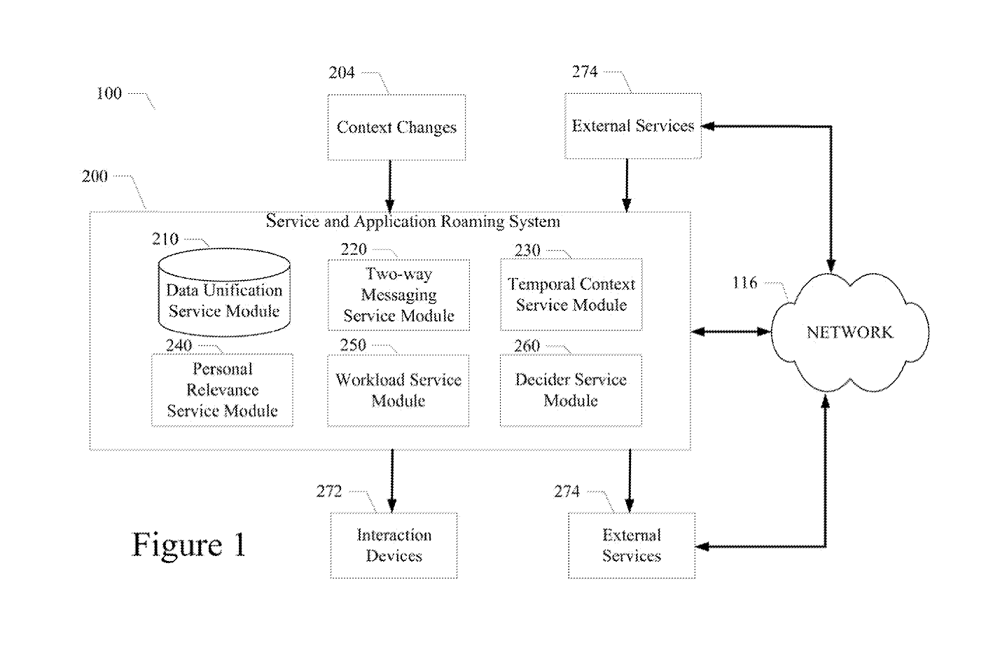

Referring now to FIG. 1, the service and application roaming system 200 of an example embodiment is shown to include a Data Unification Service Module 210, Two-way Messaging Service Module (or a Services Gateway) 220, Temporal Context Service Module 230, Personal Relevance Service Module 240, Workload Service Module 250, and Decider Service Module 260.

In addition to these core services, the Service Creation Interface specifies Application or Service intents. In one embodiment, the Service Creation Interface and an associated Service Creation Module is included as part of the Data Unification Service Module 210. The services that get created using the Service Creation Interface get listed or registered in a Directory of Available or Federated Services along with the service metadata, such as the intents that the created service can publish. The Directory of Available or Federated Services can be stored by and managed within the Data Unification Service Module 210. In one embodiment, an Experience Roaming Widget can perform look-ups in this directory to discover what services are available for roaming and what intents can be consumed enabling the user to subscribe to those application or service intents. As a result, the Data Unification Service Module 210 can provide the total available pool of apps or services that can be made available in the user's ecosystem of services and apps.

Each of these modules or components can be implemented as software components executing within an executable environment of the service and application roaming system 200. These modules can also be implemented in whole or in part as network cloud components of a linked data cloud, remote service modules, service-oriented architecture components, hardware components, or the like for processing signals and data for the service and application roaming system 200. In an example embodiment, a linked data cloud is a data network for exposing, sharing, and connecting items of data, information, and knowledge on the semantic Web using conventional data linking technologies. In one example embodiment, one or more of the service modules of the service and application roaming system 200 are executed in whole or in part on a computing platform in a vehicle. One or more of the service modules of the service and application roaming system 200 can also be executed in whole or in part on a computing platform (e.g., a server or peer-to-peer node) in the network cloud 116. In another example embodiment, one or more of the service modules of the service and application roaming system 200 are executed in whole or in past on a computing platform of a mobile device, such as a mobile telephone (e.g., iPhone™, Android™ phone, etc.) or a mobile app executing therein. Each of these service modules of an example embodiment is described in more detail below in connection with the figures provided herein.

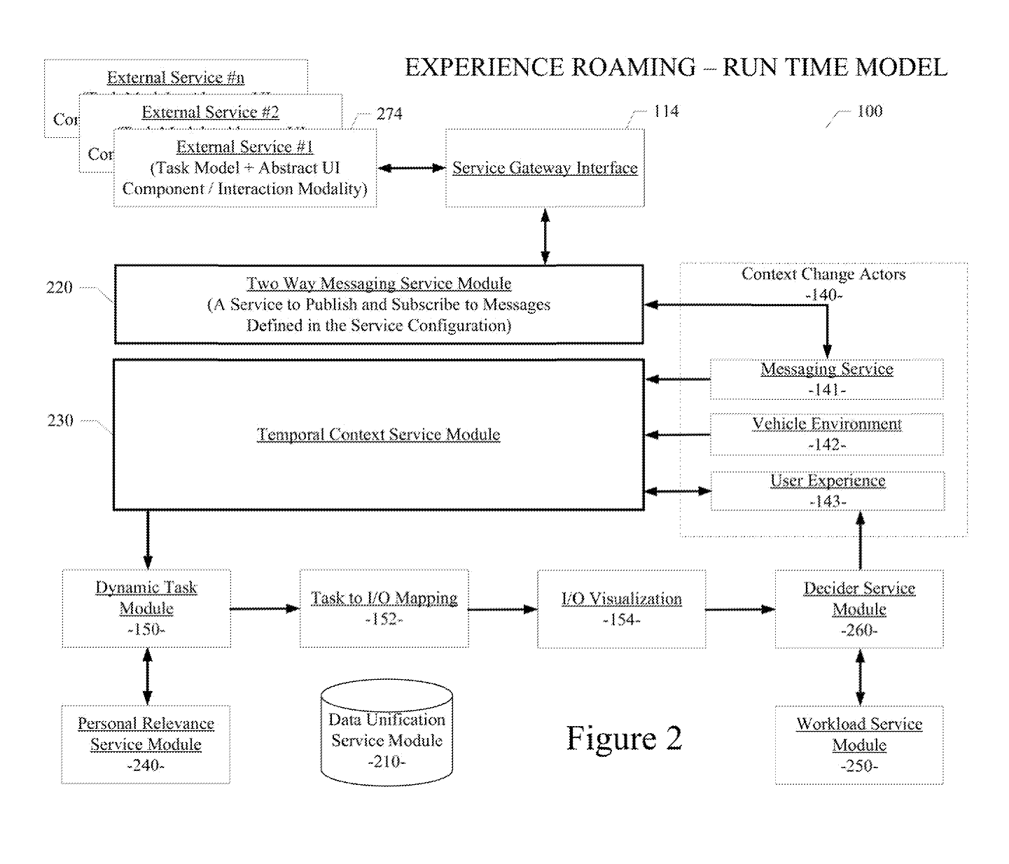

In order to deliver experience roaming, the system and method enabling service and application roaming of an example embodiment comprises the key services of the service and application roaming system 200 in the service and application roaming environment 100 as described below and illustrated in FIGS. 1 and 2.

### Data Unification Service

The Data Unification Service, implemented by the Data Unification Service Module 210 of an example embodiment, aggregates and homogenizes a user's preferences, profile, usage, data, relationships, calendar, mobile apps, and cloud services consumed by the user (e.g., service identifiers or handles) and links this data to the user's or vehicle's digital identity. A unique digital identity for the user can be created using any of a variety of conventional techniques. In one embodiment, the Data Unification Service uses the VIN (vehicle identification number) number of the vehicle as the persistent, non-repudiable identifier to create a new abstract and persistent digital identifier(s) or digital identity for the vehicle in the linked data cloud. The persistent digital identifier can be derived from a unique set of information related to a particular digital network information resource or endpoint, such as a vehicle. These persistent digital identifiers are designed so that they are both human friendly and machine friendly. As such, these persistent digital identifiers can be used across all contexts. The user's digital identity can be linked with the user's vehicle's digital identity. The digital identity can be used to associate all of the user's digital resources and the user's vehicle's digital resources in an information dataset that can be stored locally with one of the user's devices, an in-vehicle device, and/or in the linked data cloud. The Data Unification Service also links the vehicle's real-time data, such as speed, mileage, vehicle sensory and intelligence data, the vehicle's service, repairs and maintenance data to the vehicle's digital identity or identifier and makes the linked data available, under user control, with other data owned by the user. The Data Unification Service semanticizes the multi-sourced, ontologically diverse data in the dataset using a particular ontology that provides the concepts related to the user resources, the vehicle resources, and their usage in terms of entities and relationships and the network of semantic concepts, their properties, and behaviors to enable contextual exchange of data between user resources, vehicle resources, cloud resources, with the resources of other users, mobile apps, and other services. Semanticizing the data includes associating a concept with the particular data items. For example, a data item in a collection of information that identifies a particular vehicle model can be semanticized to associate the data item with a corresponding vehicle classification, such as sport utility vehicle, economy car, hybrid, or truck. Similarly, other concepts, tags, categories, or classifications can be associated with particular data items or groupings of data items from the vehicle's collection of information. Further, the concepts associated with data in the vehicle's collection of information can be arranged in a hierarchical ontology that can form links or associations between different data items at different abstraction layers. The Data Unification Service maintains the linked data associated with the vehicle resources and its user(s) resources and provides mechanisms to address and identify specific components of data. The Data Unification Service of an example embodiment can generate a unified database with an ontology of the user, the vehicle, and related resources in terms of entitles and relationships and a network of semantic concepts, their properties, and behaviors. The database can act as a knowledge end point that can be queried by and exchange messages with other services.

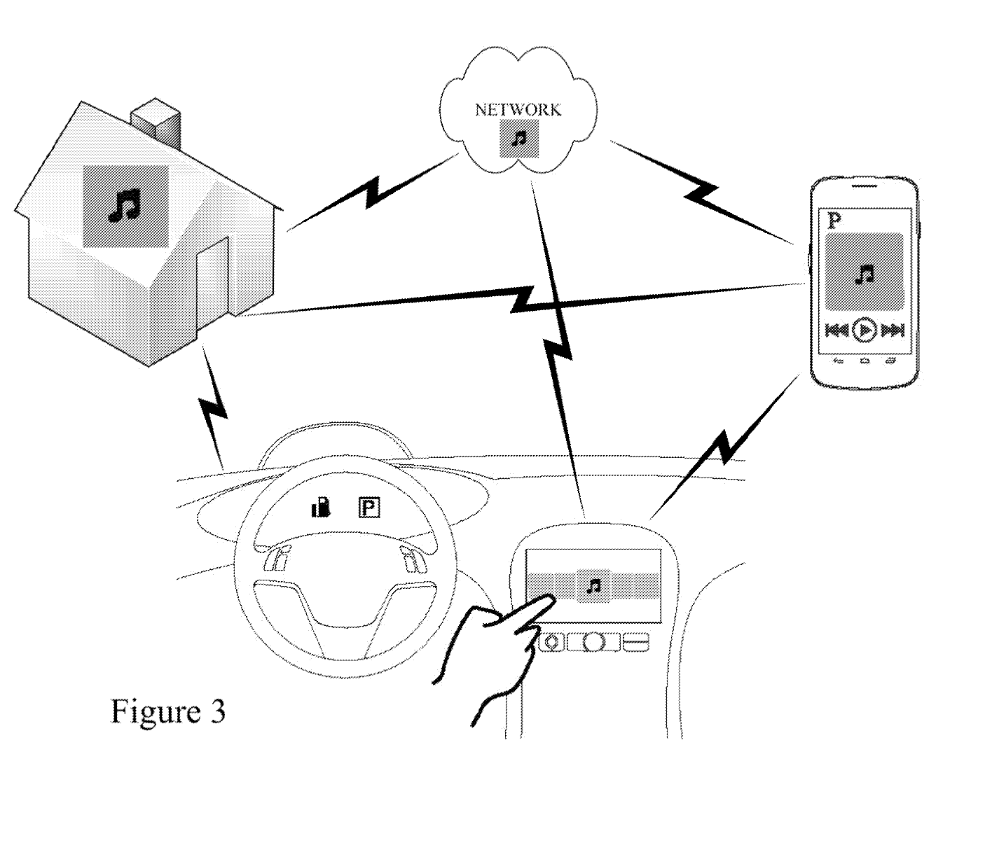

The various example embodiments described herein provide a system to unify the various data, identifiers, apps, and services, both in-vehicle and outside-the-vehicle in a unified dataset. This unified dataset is linked to the user and the vehicle's digital identity so that the data can be accessed by the user anytime, anywhere, on any device, and shared with others (under user control) in their larger social and vehicle related ecosystem as shown in FIG. 3.

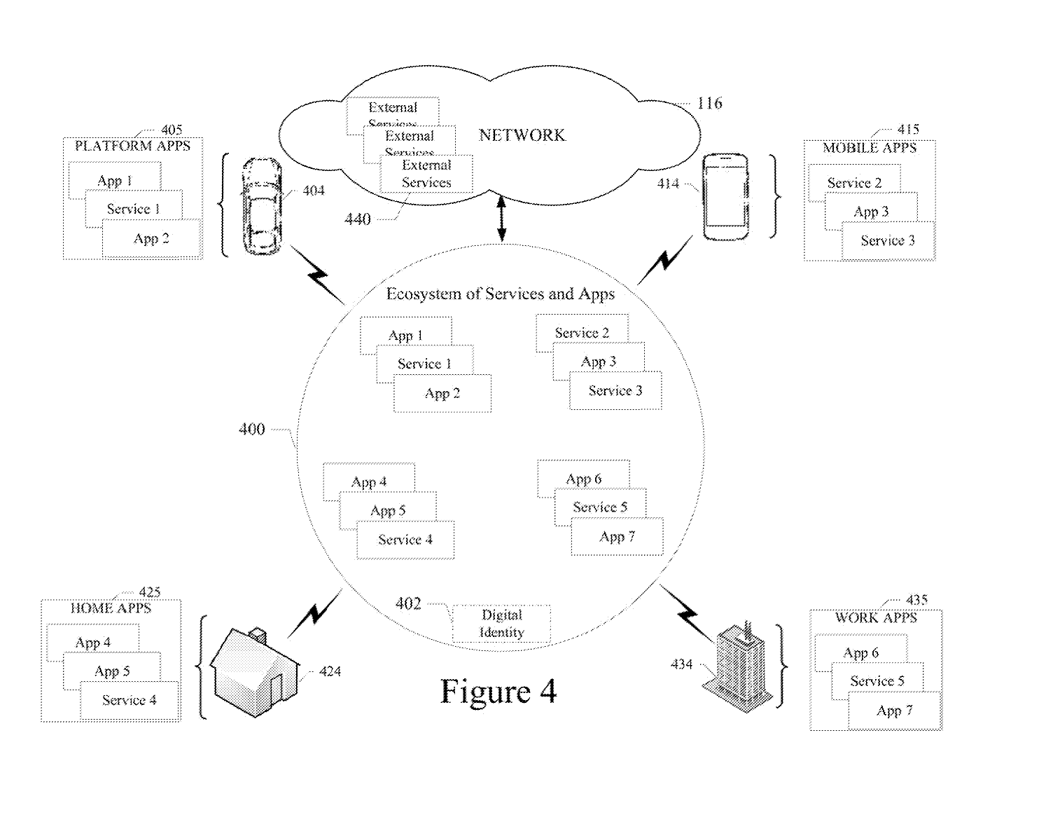

Referring to FIG. 4, as a result of the operation of the Data Unification Service, any apps or services 415 provided on a user's mobile device 414 are the total available pool of apps or services 405 that can be made available in the user's vehicle 404 in an ecosystem of services and apps 400. Similarly, any apps or services 425 provided in a user's home 424 are pooled or unified with the apps or services 435 available in the user's workplace 434 in the ecosystem of services and apps 400. The ecosystem 400 can be associated with the digital identity 402 and made accessible to or stored in the network cloud 116. Given that the ecosystem 400 is accessible to the cloud 116, the ecosystem 400 and the apps and services represented therein are also made accessible to well-known external services 440, such as Facebook™, Google™, and/or other websites or network-accessible sites or services. The unification essentially creates a linked data cloud of the user's connected life and makes parts of it available to any federated service under the control of the user.

### Two-way Messaging Service (Also Called as Services Gateway)

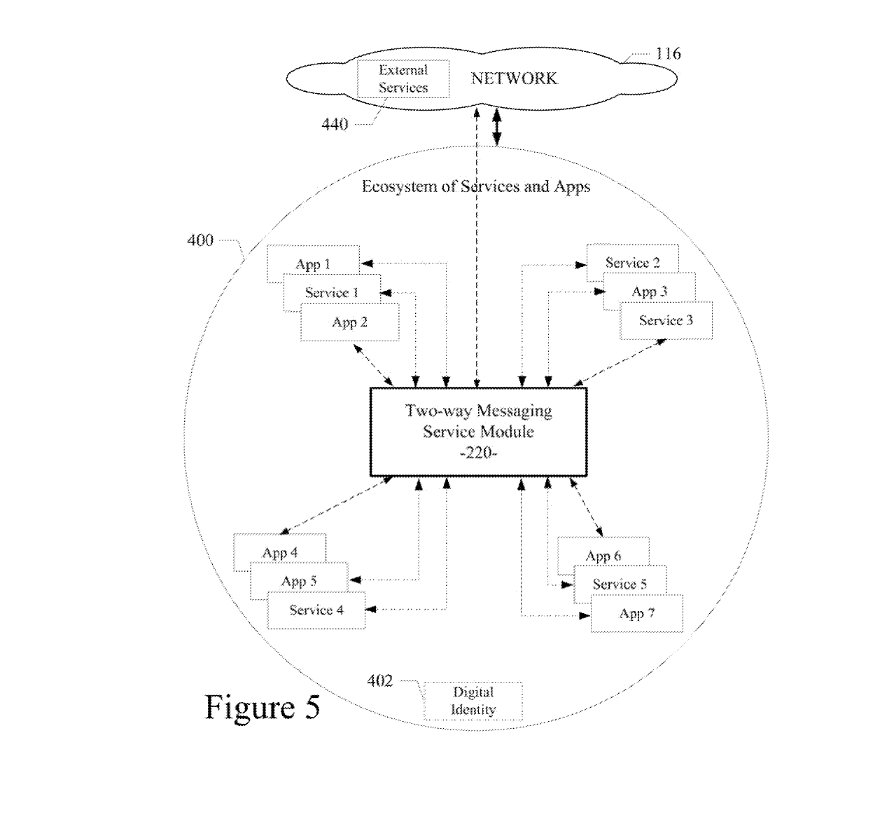

The Two-way Messaging Service, implemented by the Two-way Messaging Service Module 220 of an example embodiment, can exchange messages with the user's relationships (e.g., people, mobile apps, cloud service end-points, and the like), as well with the connected vehicle and its service end-points. The Two-way Messaging Service can receive events, triggers, signals, data, metadata, etc. (generally denoted as message data), and expose the message data to message routing logic, which can take some action relative to the input message data. For example, the message routing logic can route messages based on the message data to other end points, such as those shown in FIG. 5. The end points are the ultimate consumers of the message. The message routing logic can route a message as a request to a particular service, such as the Decider Service described below. The message routing logic can also route some messages for presentation to the user in the vehicle as notifications on one of the available interaction devices 272 (shown in FIG. 1). The message routing logic can also route some messages as metadata thereby pushing or publishing the data and/or metadata onto another application or service 274 (shown in FIG. 1), such as the user's calendar or Facebook(tm) page accessible as an external service 440 (shown in FIG. 5). In one embodiment, the external services can be routed through a service gateway interface 114 (shown in FIG. 2). The message routing logic can also route some messages as data pushed to a person via talk, text, or post channels. Again, these messages can be routed to these channels via the available interaction devices 272 and/or the external services 274/440. In other words, as shown in FIG. 5, apart from receiving and sending messages, the Two-way Messaging Service of an example embodiment performs service orchestration and provides the messaging fabric (e.g., queue, signaling, interfaces, API's, etc.) for the ecosystem of services and apps 400 to work together with the vehicle and the user in a loosely coupled manner.

When the developer of the application or service specifies the intents using the Service Creation Interface, the specified intents are advertised to the Services Gateway as intents that the service can publish at run-time and make the services available for consumption to any subscribed user. When the user configures the service using the Experience Roaming Widget, the user essentially subscribes, to the advertised, intents. In run-time, any intent to which the user subscribes is collected by the Service Gateway, which is the proxy listener for all intents that get published by the services, and routes the subscribed intents to the subscribed users.

### Temporal Context Service

The Temporal Context Service, implemented, by the Temporal Context Service Module 230 of an example embodiment, maintains the temporal context of the user and the temporal context of the vehicle factoring in the situational awareness of the vehicle (e.g., vehicle location, vehicle status, activity in and proximate to the vehicle, etc.) and situational awareness of the user's digital world/connected life (e.g., activity on the user's mobile or network-connected devices, notifications or messages from apps or connected sources, information shared from social community sources, and/or the like). The temporal context of the user or the vehicle can be determined using real-time events or data (e.g., current vehicle location, current vehicle speed, current vehicle heading, traffic conditions, weather conditions, the vehicle's operational state, etc.). The temporal context of the user or the vehicle can also be determined using asynchronous events or data, such as the number of vehicle occupants, the destination of the vehicle, whether the occupants are listening to music, talking on the phone, or accessing a calendar, whether a social community message has been received, which apps are being used in the vehicle, etc.

Referring to FIG. 2, an example embodiment of the service and application roaming environment 100 can receive inputs from at least three sources of context change information from at least three context change actors 140. These context change actors 140 include messaging service 141, vehicle environment 142, and user experience 143. The Temporal Context Service Module 230 of an example embodiment receives context, change information from each of these context change actors 140. As described above, notifications or messages from apps or connected sources, information shared from social community sources, and/or the like can be received via the messaging service 141 and conveyed to the Temporal Context Service Module 230. The content of these incoming messages can cause a context change in the service and application roaming environment 100. Similarly, real-time events or status changes in the vehicle environment 142 (e.g., current vehicle location, current vehicle speed, current vehicle heading, traffic conditions, weather conditions, the vehicle's operational slate, etc.) can cause context, changes in the service and application roaming environment 100. The real-time event or status change information originated in the vehicle environment can be conveyed to the Temporal Context Service Module 230 via the vehicle environment module 142. Moreover, the activity of one or more users in the environment can also cause context changes in the service and application roaming environment 100. For example, user interaction with interaction devices, user interaction with services or apps in the environment, user inputs, and the like can be detected by the user experience module 143 and conveyed to the Temporal Context Service Module 230.

In other words, the Temporal Context Service of an example embodiment processes a variety of data from multiple sources to assess the current state and context of the vehicle and its occupants. As such, the temporal context of the user or the vehicle pertains to the people, places, and things that are currently relevant to the vehicle occupants based on an awareness of their unified digital life within the network cloud and the vehicle's information ecosystem. In a manner described below in relation to the Decider Service Module 260, a change to a current context in the environment 100, as determined by the Temporal Context Service Module 230, can cause a variety of tasks to be performed in response to the context change. The identification and activation of these tasks in response to the context change are performed by the dynamic task module 150, the task to I/O mapping module 152, the I/O visualization module 154, and the Decider Service Module 260 as described in detail below.

### Personal Relevance Service

The Personal Relevance Service, implemented by the Personal Relevance Service Module 240 of an example embodiment shown in FIGS. 1 and 2, scores the relevancy (e.g., generates a relevance score) corresponding to the importance of a communication conveyed to the user in the vehicle from an end point (e.g., a mobile app, a cloud service, a vehicle service, or the like). The Personal Relevance Service computes the relevance score or presentation confidence score based on information including: 1) the type of information received (e.g., an alert, reminder, event, notification from a mobile app or cloud service or the vehicle itself, an email, a voice mail, a calendar event, or other message or request conveyed to the user from an end point); 2) the time sensitivity of the message, event, or request, as related to the user's current context; 3) whether or not some action is requested by the user; 4) the user's past behavior in handling such messages, events, or requests; 5) the behavior of other semantically similar people to such messages, events, or requests; and 6) a semantic understanding of the message, event, or request, the entities and relationships that the message, event, or request affects, and many other parameters. The Personal Relevance Service also annotates the received message, event, or request by querying the Temporal Context Service (described above), dispatching a set of queries to multiple endpoints (e.g., services in the network cloud, etc.) to reason and infer what information can be ignored or deferred, what information needs to be presented to the user, and how soon the information needs to be presented to the user. As a result of this scoring performed by the Personal Relevance Service, the Decider Service, described below, can determine how and when to present information and content to the user or driver in a manner that is efficient, consistent with the user's prior behavior/preferences, and consistent the behavior/preferences of similar users.

### Workload Service

The Workload Service, implemented by the Workload Service Module 250 of an example embodiment, determines the current workload (e.g., manual visual, and cognitive) on the user or driver based on the temporal context of the vehicle as obtained from the Temporal Context Service as described above and the temporal context of the user also obtained from the Temporal Context Service as described above. The Workload Service also computes a safety window that is available at any given point of time for the various types of workloads. The safety window provides information indicative of a relation between the current workload of the user relative to an operational limit of the user for the related activity. For example, the Workload Service can determine with which vehicle subsystems the user/vehicle driver is currently interacting or from which vehicle subsystems messages, events, or requests are being received. The driver may be configuring the vehicle's audio system as the navigation subsystem signals an imminent directional change as an incoming telephone call is received. The Workload Service can score these concurrent messages, events, or requests in a manner indicative of the level of attention the driver is likely to pay to any one message, event, or request. The Workload Service can score the user's workload highly (e.g., a relatively high score) when multiple, high-priority requests to the user are pending. As a result, the safety window is correspondingly reduced (e.g., a relatively small safety window). In contrast, the Workload Service can score the user's workload lowly (e.g., a relatively low score) when only a few requests or only low-priority requests to the user are pending. As a result, the safety window is correspondingly increased (e.g., a relatively large safety window). In this manner, the Workload Service of an example embodiment can determine or infer a level to which a driver may be distracted by operation of the vehicle of activities in or around the vehicle. As a result of this user/driver workload determination performed by the Workload Service, the Decider Service, described below, can determine how and when to present information and content to the user or driver in a manner that will not detrimentally affect the driver workload or safety window.

### Decider Service

The Decider Service, implemented by the Decider Service Module 260 of an example embodiment, mediates and determines: 1) the content of the information (e.g., data, metadata, context, etc.) that gets presented to the user; 2) where the information gets presented (e.g., a heads-up display, an extended instrument cluster, an IVI screen, a speaker in the vehicle, or another endpoint, such as a mobile app, a cloud service, or the like); 3) how the information gets presented (e.g., voice, display, or both); and 4) the qualitative aspects of the presentation, such as a notification type (alert, reminder, critical event), the usage of text, image, hierarchy, focus, etc. The Decider Service receives input from the Temporal Context Service, the Personal Relevance Service, the Workload Service (described above), and other services to ultimately decide when to ignore an incoming intent (message, event, or request), or when to use the intent (message, event, or request) as a suggestion to be cached to be presented to the user at a later time (such as when the vehicle is parked) or to consider the message, event, or request as an assertion that needs to be presented to the user in the safest and most expedient manner. Additionally, the Decider Service determines if any other related information needs to be presented (metadata) with the information that gets selected for presentation. The Decider Service also determines if any user selection is required and if so, what input modes to make available to the user for selection (e.g., voice response, touch, gesture, gaze, etc.). The Decider Service maintains the overall context and state of the experience and ensures that the experience is smooth and integrated as its state transfers or the context changes. The Decider Service can use a dynamic task module to translate an intent into a task or a set of tasks; and cause a task set to be performed in response to the context change. The activation of the task set can cause a set of interaction resources, corresponding to the task set, to be dispatched to present a state of the current context to a user by use of a plurality of interaction devices corresponding to the set of interaction resources, the set of interaction resources being accessed using the plurality of user services and applications in the shared ecosystem of services and applications. The processing performed by the Decider Service is described in more detail below.

As described above, the Temporal Context Service Module 230 can detect a change to a current context in the environment 100. As a result, the Temporal Context Service Module 230 can signal a context change to the dynamic task module 150, as shown in FIG. 2, to cause a variety of tasks or a task set to be performed in response to the context change. The identification and activation of these tasks in response to the context change are performed by the dynamic task module 150, the task to I/O mapping module 152, the I/O visualization module 154, and the Decider Service Module 260 as described below.

The Decider Service Module 260 uses the dynamic task module 150 and the task to I/O mapping module 152 to compute the set of tasks (based on the subscribed intents that got published by the App or Service in run-time and got routed to the App or Service by the Services Gateway) that need to be made available in a given context and maps the set of tasks onto interaction resources supporting the temporally relevant tasks. Interaction resources are end points (e.g., apps, services, devices, etc.) through which a user can consume (e.g., view, listen or otherwise experience) output produced by another resource. For example, keyboards, screens, display surfaces, and speech synthesizers, are all examples of physical interaction resources that are attached to some computing device in the environment 100. Each interaction resource is associated with one of the interaction devices 272. The Decider Service Module 260 then uses the I/O visualization module 154 to visualize the set of tasks using concrete interfaces and deploys the set of tasks on available interaction devices 272 using the interaction resources. The Decider Service Module 260 uses a mapping and planning process to compute an efficient execution of the required tasks for the context change with the interaction resources that are available. Specifically, the Decider Service Module 260 receives an indication of context changes captured in the current context from the Temporal Context Service Module 230 and performs a set of coordinated steps to transition a current state of the user experience to a new state that is appropriate and relevant to the changed context. In order to detect context changes, the current context is drawn from a variety of context sources 140 as described above. Additionally, the Decider Service Module 260 uses the scoring produced by the Personal Relevance Service, to determine how and when to present information and content to the user or driver on the available interaction devices 272 in a manner that is efficient, consistent with the user's prior behavior/preferences, and consistent the behavior/preferences of similar users. Moreover, the Decider Service Module 260 uses the user/driver workload determination produced by the Workload Service to determine how and when to present information and content to the user or driver on the available interaction devices 272 in a manner that will not detrimentally affect the driver workload or safety window.

The services of the service and application roaming system 200 enable the system to be always aware of the user's network-connected life, their vehicle, and the activity around their vehicle. The service and application roaming system 200 can exchange two way messages and events with the user's mobile apps and cloud services outside the car, as well as messages and data from the set of in-vehicle services, such as live traffic and navigation and the data and messages from the vehicle and other cloud based vehicle services. This awareness is used to determine user's current workload as well as the confidence score and relevancy of what is being requested to be presented to the user. The service and application roaming system 200 can determine what gets presented to the user, where, and how in a manner that is vehicle appropriate to provide a holistic roaming experience to the user.

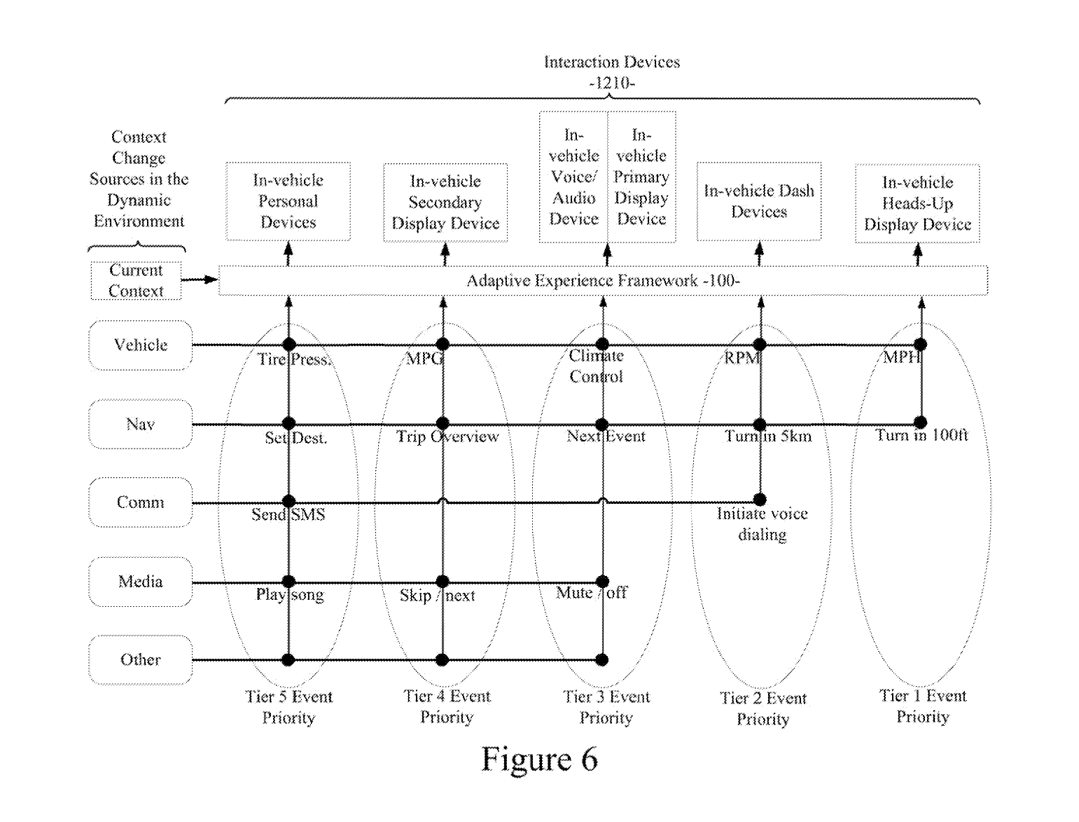

Referring now to FIG. 6, an example of the operation of the service and application roaming system 200 in a vehicle environment is illustrated. As shown, the vehicle environment can source a variety of context change events or notifications (e.g., events from a variety of vehicle subsystems, such as vehicle sensors, a navigation subsystem, a communication subsystem, a media subsystem, and subscribed intents from apps and services and the like. Each context change event or notification can have a particular priority or level of criticality in the dynamic environment. As a result of these context changes, the service and application roaming system 200 can assign a corresponding task set, as described above, to cause information or content presentations on one or more of the interaction devices 1210 in the vehicle environment. Because the service and application roaming system 200 is holistically aware of the vehicle environment, the service and application roaming system 200 can present the intent via related information, content and interaction to the user in a context-sensitive and priority-sensitive manner that is most likely to convey necessary information to the driver in the least distracting manner possible. For example, a message to the driver from the navigation subsystem regarding a high priority imminent turn can be shifted to the heads-up display (HUD), even though the message might be usually displayed on the primary display device on the dashboard. Similarly, while the high priority navigation message is being presented, less important messages In the particular context, such as those from the media or communication subsystems, can be suppressed or delayed until the higher priority presentations are completed. This is just one representative example of the dynamic nature of the service and application roaming system 200 as described herein.

In summary, the various embodiments extend and abstract a user's interaction with information related to a vehicle to a general concept called Experience Roaming—extending the user's experience in one location to other locations, without losing the experience, including when an experience is in progress. As an example of Experience Roaming in the context of a vehicle, consider a user who uses an application for navigation or an application for finding fuel stations. In the absence of Experience Roaming as described for various embodiments herein, when the user wants to refuel the car, they would launch a fuel finder application like Gas Buddy that will provide them a listing of nearby fuel stations. The user can sort the listing and order the items in the listing by price, brand, or distance; make an appropriate selection; and then cut/copy/paste the address of the selected item into the navigation system, which would provide the route and directions to the location of the selected item. Unfortunately, this user experience is fragmented and requires manual detection of the low fuel event, manual search (of nearby gas stations), interaction with search results, data entry of a selected search result, and application switching.

Now consider a similar scenario wherein the vehicle telematics (e.g., a vehicle subsystem status service, including fuel level status), navigation, and fuel finder applications can publish intents that are subscribed to by the user or a user processing system in the manner described above. When the vehicle telematics service detects that the vehicle is running low on fuel (e.g., a context change), the vehicle telematics service can publish this event notification as an intent to the service and application roaming environment 100. The service and application roaming environment 100 of an example embodiment can consume (i.e., receive and process) this intent and map the intent to an implicit task of finding nearby fuel stations. The service and application roaming environment 100 can invoke an advertised intent of the fuel finder application (e.g., the advertised intent of the fuel finder application can correspond to a service for finding a nearby fuel station). In this case, the advertised intent is a service that the fuel finder application can provide and had previously advertised to the service and application roaming environment 100. In this manner, the service and application roaming environment 100 can connect or map a service requester with a service provider in the service and application, roaming environment 100. Once the fuel finder application provides the results from its service for finding nearby fuel stations, the service and application roaming environment 100 can further map the results as an intent to a user preferences service, which has also advertised its services to the service and application roaming environment 100. The user preferences service can further process the results from the service for finding nearby fuel stations by selecting one or more nearby fuel stations that match known (e.g., explicitly user specified) and/or learned (e.g., implicitly determined based on previous user behavior) preferences of the user. Once the user preferences service has selected a preferred nearby fuel station, the results from the user preferences service can be conveyed to the service and application roaming environment 100 in the manner described above (e.g., the Two-Way Messaging Service Module 220). At this point in the sample scenario, the service and application roaming environment 100 can determine the best or preferred way to convey the low fuel information, and the preferred nearby fuel station option to the user/driver based on the current context of the vehicle and driver at the particular time. In one example, the service and application roaming environment 100 can present the “Low Fuel” notification intent to the user/driver in a manner consistent with the context of the vehicle and driver (e.g., audibly via a speech generation device, or visually via a low fuel icon on a display surface). Concurrently, the service and application roaming environment 100 can present a notification intent to the user offering the user the option of receiving navigation information directing the user/vehicle to the preferred nearby fuel station. The service and application roaming environment 100 can also configure the various available vehicle user interaction devices or external devices for receiving user/driver input in a manner consistent with the context of the vehicle and driver (e.g., audibly via a speech reception/recognition device, or by touch via a button on an interaction device). If the user/driver accepts the option to receive navigation instructions to the preferred nearby fuel station, the service and application roaming environment 100 can send an intent to the navigation subsystem with information indicative of the location of the preferred nearby fuel station. As a result the navigation subsystem will provide directions to the preferred nearby fuel station. All this orchestration and presentation as described in the sample scenario above gets handled silently in/by the service and application roaming environment 100, without any explicit and/or repeated interaction by the user/driver, except after the service and application roaming environment 100 has detected an event, processed the options, and ultimately asked the user/driver for an option selection in a manner suited to the current context of the vehicle/driver at the particular time.

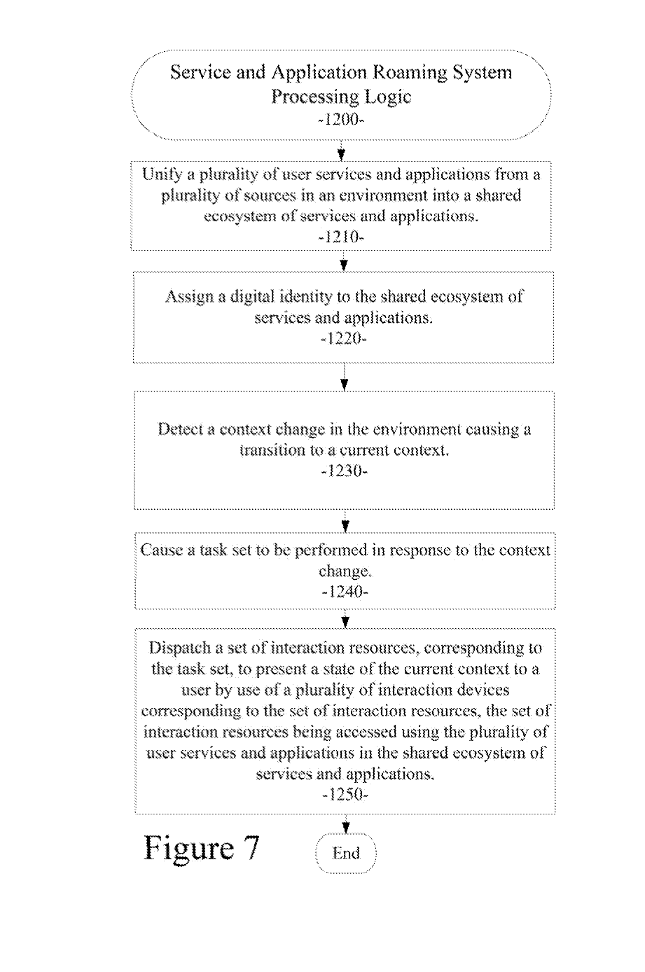

FIG. 7 is a processing flow diagram illustrating an example embodiment of a system and method enabling service and application roaming as described herein. The method 1200 of an example embodiment includes: unifying a plurality of user services and applications from a plurality of sources in an environment into a shared ecosystem of services and applications (processing block 1210); assigning, by use of a data processor, a digital identity to the shared ecosystem of services and applications (processing block 1220); detecting a context change in the environment causing a transition to a current context (processing block 1230); causing a task set to be performed in response to the context change (processing block 1240); and dispatching a set of interaction resources, corresponding to the task set, to present a state of the current context to a user by use of a plurality of interaction devices corresponding to the set of interaction resources, the set of interaction resources being accessed using the plurality of user services and applications in the shared ecosystem of services and applications (processing block 1250).

Thus, a system and method enabling service and application roaming are disclosed.

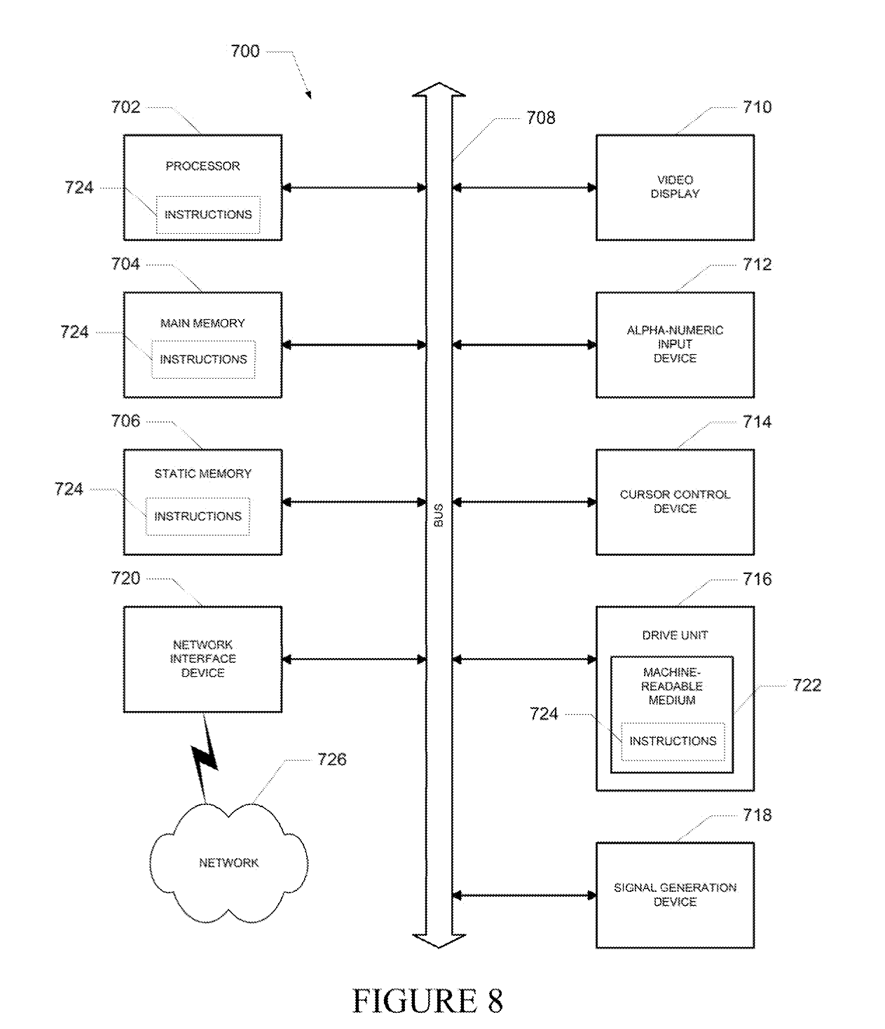

FIG. 8 shows a diagrammatic representation of machine in the example form of a computer system 700 within which a set of instructions when executed may cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” can also be taken to include any collection of machines that individually or jointly execute a set (or multiple sets) of instructions to perform any one or more of the methodologies discussed herein.

The example computer system 700 includes a data processor 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a non-transitory machine-readable medium 722 on which is stored one or more sets of instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720. While the machine-readable medium 722 is shown in an example embodiment to be a single medium, the term “machine-readable medium” should be taken to include a single non-transitory medium or multiple media (e.g., a centralized or distributed database, and/or associated caches and servers) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
unifying a plurality of user services and applications from a plurality of sources in an environment into a shared ecosystem of services and applications;
assigning, by use of a data processor, a digital identity to the shared ecosystem of services and applications;
detecting a context change in the environment causing a transition to a current context;
causing a task set to be performed in response to the context change; and
dispatching a set of interaction resources, corresponding to the task set, to present a state of the current context to a user by use of a plurality of interaction devices corresponding to the set of interaction resources, the set of interaction resources being accessed using the plurality of user services and applications in the shared ecosystem of services and applications.

2. The method as claimed in claim 1 including specifying, publishing, and subscribing to application or service intents.

3. The method as claimed in claim 1 wherein detecting the context change includes receiving an indication of user interaction with a user interface or receiving a notification from an application, service, or data provider.

4. The method as claimed in claim 1 wherein detecting the context change includes receiving an indication from an external source.

5. The method as claimed in claim 1 wherein the services and applications of the shared ecosystem of services and applications can be accessed using the digital identity.

6. The method as claimed in claim 1 including scoring a relevancy corresponding to an importance of a communication conveyed to the user from an end point.

7. The method as claimed in claim 1 including presenting information to the user in a manner that is consistent with the user's prior behavior and preferences.

8. The method as claimed in claim 1 including generating a workload score indicative of a level of attention the user is likely to pay to a communication conveyed to the user from an end point.

9. The method as claimed in claim 1 wherein the environment is a vehicle environment.

10. A system comprising:
one or more data processors; and
a service and application roaming system, executable by the one or more data processors, to:
unify a plurality of user services and applications from a plurality of sources in an environment into a shared ecosystem of services and applications;
assign a digital identity to the shared ecosystem of services and applications;
detect a context change in the environment causing a transition to a current context;
cause a task set to be performed in response to the context change; and
dispatch a set of interaction resources, corresponding to the task set, to present a state of the current context to a user by use of a plurality of interaction devices corresponding to the set of interaction resources, the set of interaction resources being accessed using the plurality of user services and applications in the shared ecosystem of services and applications.

11. The system as claimed in claim 10 being further configured to specify, publish, and subscribe to application or service intents.

12. The system as claimed in claim 10 being further configured to detect the context change by receiving an indication of user interaction with a user interface or by receiving a notification from an application, service, or data provider.

13. The system as claimed in claim 10 being further configured to detect the context change by receiving an indication from an external source.

14. The system as claimed in claim 10 wherein the services and applications of the shared ecosystem of services and applications can be accessed using the digital identity.

15. The system as claimed in claim 10 being further configured to score a relevancy corresponding to an importance of a communication conveyed to the user from an end point.

16. The system as claimed in claim 10 being further configured to present information to the user in a manner that is consistent with the user's prior behavior and preferences.

17. The system as claimed in claim 10 being further configured to generate a workload score indicative of a level of attention the user is likely to pay to a communication conveyed to the user from an end point.

18. The system as claimed in claim 10 wherein the environment is a vehicle environment.

19. A non-transitory machine-useable storage medium embodying instructions which, when executed by a machine, cause the machine to:
unify a plurality of user services and applications from a plurality of sources in an environment into a shared ecosystem of services and applications;
assign a digital identity to the shared ecosystem of services and applications;
detect a context change in the environment causing a transition to a current context;
cause a task set to be performed in response to the context change; and
dispatch a set of interaction resources, corresponding to the task set, to present a state of the current context to a user by use of a plurality of interaction devices corresponding to the set of interaction resources, the set of interaction resources being accessed using the plurality of user services and applications in the shared ecosystem of services and applications.

20. The machine-useable storage medium as claimed in claim 19 wherein the environment is a vehicle environment.
